(19) United States
(12) Patent Application Publication
(10) Pub. No.: US 2006/0145988 A1
(43) Pub. Date: Jul. 6, 2006

(54) Active matrix liquid crystal display

(75) Inventors: Tsau Hua Hsieh, Miao-Li (TW); Jia-Pang Pang, Miao-Li (TW); Chien-ting Lai, Miao-Li (TW)

Correspondence Address: WEI TE CHUNG;FOXCONN INTERNATIONAL, INC., 1650 MEMOREX DRIVE, SANTA CLARA, CA, 95050, US

(73) Assignee: INNOLUX DISPLAY CORP.

(21) Appl. No.: 11/323,890

(22) Filed: Dec. 30, 2005

(30) Foreign Application Priority Data
Dec. 31, 2004 (TW) 93141599

(51) Int. Cl. G09G 3/36

(52) U.S. Cl. 345/92

(57) ABSTRACT

An LCD (10) includes a plurality of first and second scanning lines (11, 12) that each extend along a first direction; a plurality of first and second signal lines (21, 22) that each extend along a second direction orthogonal to the first direction; a plurality of scanning connection lines (13) electrically connecting with the first and the second scanning lines; a plurality of first TFTs (31) each provided in the vicinity of intersection of the first scanning lines and the first signal lines; a plurality of second TFTs (32) each provided in the vicinity of intersection of the second scanning lines and the second signal lines. The second TFTs connected to the second scanning line opens in turn and delays after the corresponding first TFTs opens, and the second signal line supply a black-insertion voltage to reset the liquid crystal black when the second TFT opens.

### FIELD OF THE INVENTION

The present invention relates to liquid crystal displays (LCDs), and particular to an active matrix type LCD which is suitable for motion picture display.

### BACKGROUND

Because LCD devices have the advantages of portability, low power consumption, and low radiation, they have been widely used in various portable information products such as notebooks, personal digital assistants (PDAs), video cameras, and the like. Furthermore, LCD devices are considered by many to have the potential to completely replace CRT (cathode ray tube) monitors and televisions.

FIG. 6 is an abbreviated circuit diagram of a typical active matrix LCD. The active matrix LCD 100 includes a glass first substrate (not shown), a glass second substrate (not shown) facing the first substrate, a liquid crystal layer (not shown) sandwiched between the first substrate and the second substrate.

The first substrate includes a number n (where n is a natural number) of scanning lines 101 that are parallel to each other and that each extend along a first direction, and a number m (where m is also a natural number) of signal lines 102 that are parallel to each other and that each extend along a second direction orthogonal to the first direction. The first substrate also includes a plurality of thin film transistors (TFTs) 104 that function as switching elements. The first substrate further includes a plurality of pixel electrodes 103 formed on a surface thereof facing the second substrate. Each TFT 104 is provided in the vicinity of a respective point of intersection of the scanning lines 101 and the signal lines 102.

Each TFT 15 includes a gate electrode 1040, a source electrode 1041, and a drain electrode 1042. The gate electrode 1040 of each TFT 104 is connected to the corresponding scanning line 101. The source electrode 1041 of each TFT 104 is connected to the corresponding signal line 102. The drain electrode 1042 of each TFT 104 is connected to a corresponding pixel electrode 103.

The second substrate includes a plurality of common electrodes 105 opposite to the pixel electrodes 103. In particular, the common electrodes 105 are formed on a surface of the second substrate facing the first substrate, and are made from a transparent material such as ITO (Indium-Tin Oxide) or the like. A pixel electrode 103, a common electrode 105 facing the pixel electrode 103, and liquid crystal molecules of the liquid crystal layer sandwiched between the two electrodes 103, 105 cooperatively define a liquid crystal capacitance 107.

FIGS. 8 and 9 diagrammatically show waveforms of the gate electrodes 1040 and the source electrodes 1041 of the TFTs 104. FIG. 10 shows waveforms of the pixel electrodes 103. In operation, regarding just one of the TFTs 104, at the time t1, the source electrode 1041 is supplied a signal voltage V_{d}, and the gate electrode 1040 is supplied a scanning pulse Vg in sequence. The TFT 104 is open and the signal voltage V_{d} is applied to the pixel electrode 103 via the source electrode 1041 and the drain electrode 1042 of the TFT 104. At the time t2, the TFT 104 is closed, but the signal voltage V_{d} is kept by the capacitance 107 until the time t3, when the TFT 104 is reopened. As shown in the FIG. 10, the pixel voltage follows the signal voltage V_{d}. In the time from t1 to t2, the pixel voltage increases to Vₚ₁, and in the time from t2 to t3, the voltage Vₚ₁ is maintained by the liquid crystal capacitance 107. In the period of one time frame, such as during the period t1˜t3, the pixel voltage is Vₚ₁ and the display using the active matrix driver 100 is in the white mode. In the period of a next time frame, the pixel voltage may be another value such as Vₚ₂, for displaying different grays.

The LCD device using the active matrix driver 100 displays images through different voltages Vₚ applied to the pixel electrode 103. In other words, the gray level of the display is determined by the voltage Vₚ. Typically, each next time frame should be accompanied by a quick change in the voltage Vₚ, for providing good display performance when the display shows dynamic pictures. If Vₚ₂ is much more than Vₚ₁ or much less than Vₚ₁, then these two time frames can be displayed clearly. However, if Vₚ₂ is not much more than Vₚ₁ or not much less than Vₚ₁ at the next frame, the gray level is just a little higher or lower than before, and the difference between the two applied voltages is small. Because liquid crystals are “adhesive,” the liquid crystal layer needs more time to change from one station to the next station. The next gray picture may cover the last gray picture, making the display image blurred.

It is desired to provide an active matrix LCD that can overcome the above-described deficiencies.

### SUMMARY

An active matrix liquid crystal display (LCD) of a preferred embodiment of the present invention includes a plurality of first and second scanning lines that are parallel to each other and that each extend along a first direction; a plurality of first and second signal lines that are parallel to each other and that each extend along a second direction orthogonal to the first direction; a plurality of scanning connection lines electrically connecting with the first and the second scanning lines; a plurality of first thin film transistors (TFTs) each provided in the vicinity of a respective point of intersection of the first scanning lines and the first signal lines; a plurality of second thin film transistors (TFTs) each provided n the vicinity of a point of intersection of the second scanning lines and the second signal lines. The second TFTs connected to the second scanning line opens in turn and delays after the corresponding first TFTs connected to the first scanning line opening, and the second signal line supply a black-insertion voltage to reset the liquid crystal black when the second TFT opens.

Other advantages and novel features will become more apparent from the following detailed description when taken in conjunction with the accompanying drawings, in which:

### BRIEF DESCRIPTION OF THE DRAWINGS

FIG. 1 is an abbreviated circuit diagram of an active matrix LCD according to an exemplary embodiment of the present invention, the active matrix driver comprising a number of first and second TFTs and pixel electrodes;

FIG. 2 is an abbreviated circuit diagram of a plurality of scanning lines of the active matrix LCD of FIG. 1.

FIG. 3 is a voltage waveform, showing a voltage of a scanning line numbered i varying over time of the active matrix LCD of FIG. 1;

FIG. 4 is voltage waveform, showing a voltage of a scanning line numbered i+(n/a) varying over time of the active matrix LCD of FIG. 1;

FIG. 5 is voltage waveform, showing a voltage of a pixel electrode connecting with the corresponding scanning line numbered i+(n/a) varying over time of the active matrix LCD of FIG. 1;

FIG. 6 is an abbreviated circuit diagram of a typical a active matrix LCD;

FIG. 7 is an abbreviated circuit diagram of a display unit of the typical matrix LCD of FIG. 1.

FIG. 8 is voltage waveform, showing a voltage of a scanning electrode of a TFT varying over time of the typical matrix LCD of FIG. 6;

FIG. 9 is voltage waveform, showing a voltage of a source electrode of a TFT varying over time of the typical active matrix LCD of FIG. 6;

FIG. 10 is voltage waveform, showing a voltage of a pixel electrode varying over time of the active matrix LCD of FIG. 6;

### DETAILED DESCRIPTION OF PREFERRED EMBODIMENTS

Reference will now be made to the drawings to describe the present invention in detail.

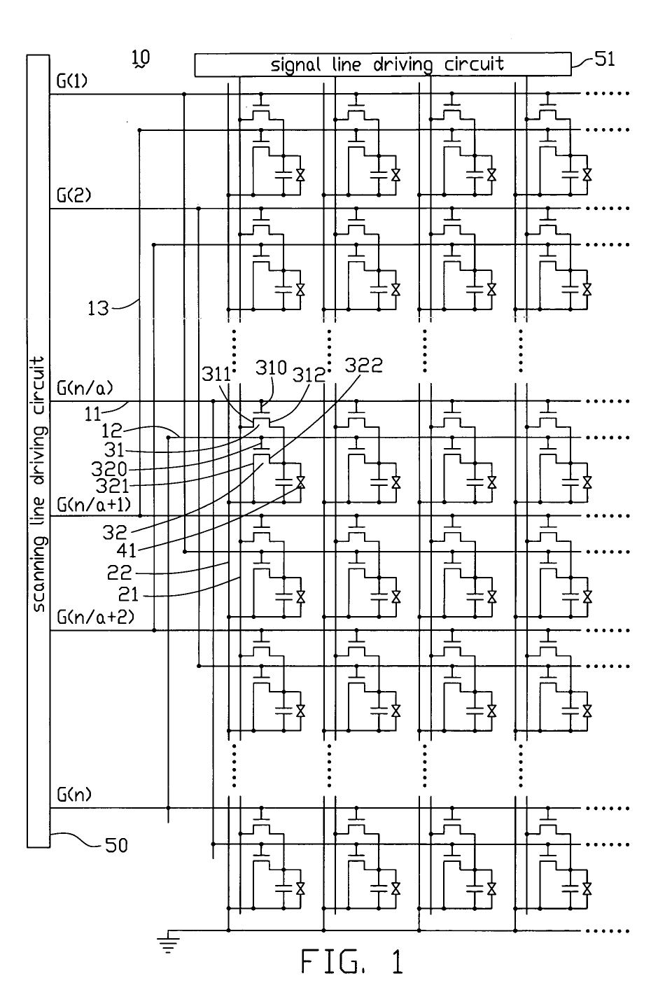

FIG. 1 is an abbreviated circuit diagram of an active matrix LCD according to an exemplary embodiment of the present invention. The active matrix LCD 10 includes a glass first substrate (not shown), a glass second substrate (not shown) facing the first substrate, a liquid crystal layer (not shown) sandwiched between the first substrate and the second substrate, a plurality of scanning line driving circuits 50, a plurality of signal line driving circuits 51.

The first substrate includes a number n (where n is a natural number) of first scanning lines 11 that are parallel to each other and that each extend along a first direction, a number n (where n is a natural number) of second scanning lines 12 that are parallel to each other and that are parallel to the first scanning lines 11, a number m (where n is a natural number) of first signal lines 21 that are parallel to each other and that each extend along a second direction orthogonal to the first direction, and a number m (where n is a natural number) of second signal lines 22 that are parallel to each other and that are parallel to the first signal lines 21. The first substrate also includes a plurality of first TFTs (thin film transistors) 31 and a plurality of second TFTs 32 that function as switching elements. The first substrate further includes a plurality of pixel electrodes 41 formed on a surface thereof facing the second substrate. Each first TFT 31 is provided in the vicinity of a respective point of intersection of the first scanning lines 11 and the first signal lines 21. Each second TFT 32 is provided in the vicinity of a respective point of intersection of the second scanning lines 12 and the second signal lines 22.

Each TFT 31, 32 includes a gate electrode 310, 320, a source electrode 311, 321, and a drain electrode 312, 322. The gate electrode 310 of the first TFT 31 is connected to the corresponding first scanning line 11. The source electrode 311 of the first TFT 31 is connected to the corresponding first signal line 21. The drain electrode 312 of the first TFT 31 is connected to a corresponding one of the pixel electrodes 41. The gate electrode 320 of the second TFT 32 is connected to the corresponding second scanning line 12. The source electrode 321 of the second TFT 32 is connected to the corresponding second signal line 22. The drain electrode 322 of the second TFT 32 is connected to a corresponding one of the pixel electrodes 41.

Referring to FIG. 2, the active matrix LCD 10 further comprises a number n of scanning connecting lines 13 between the first scanning line 11 (denoted by the real line) and the corresponding second scanning line 12 (denoted by the broken line). The scanning connecting line 13 electrically connect the first scanning line 11 and the corresponding second scanning line 12, such as the first scanning line 11 numbered i electrically connects with the second scanning line 12 numbered (n/a)+i, when (n/a)+i≦n; the first scanning line 11 numbered i electrically connects with the second scanning line 12 numbered (n/a)+i−n, when (n/a)+i≧n. In which, n is the number of the first scanning lines 11, and a is pulse index. The pulse index a is a display time t divided by a frame time T, i.e. a=t/T. Number n is an integral times to pulse index a.

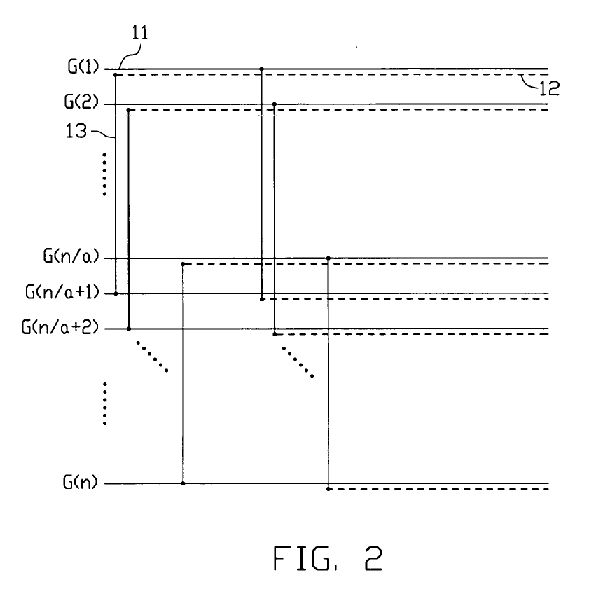

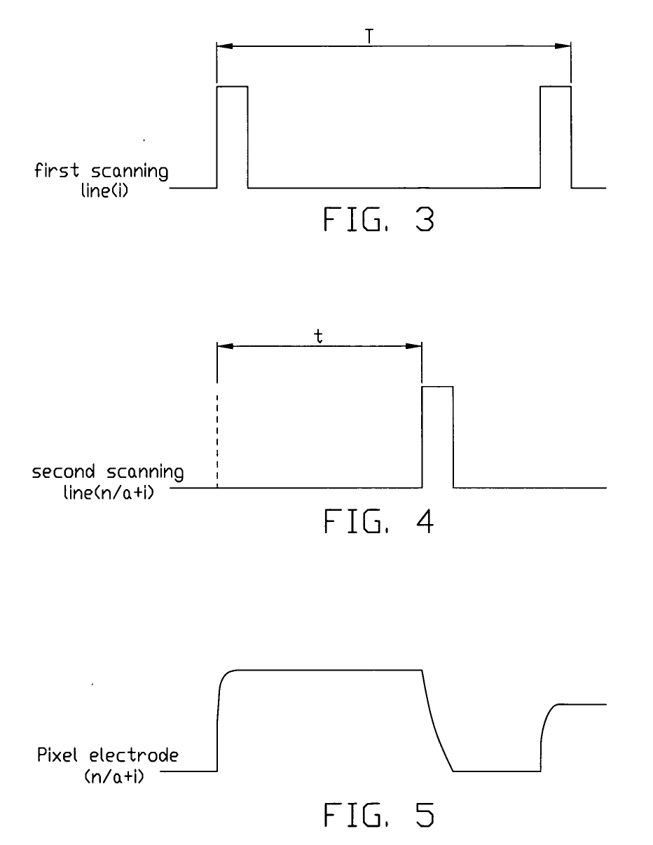

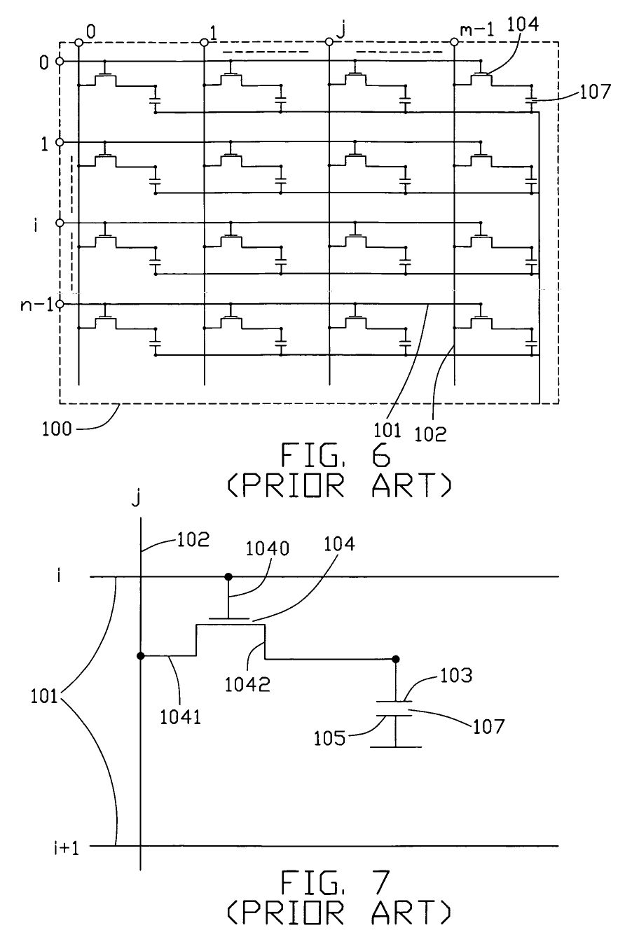

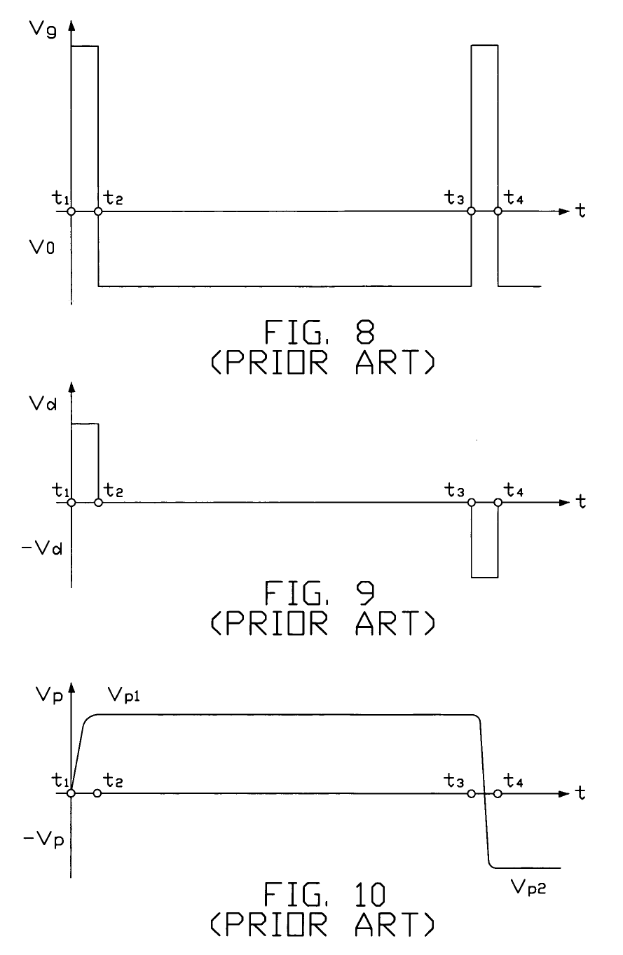

FIG. 3 is a voltage waveform, showing a voltage of a first scanning line numbered i varying over time. FIG. 4 is voltage waveform, showing a voltage of a second scanning line numbered i+(n/a) varying over time. FIG. 5 is voltage waveform, showing a voltage of a pixel electrode connecting with the scanning line numbered i+(n/a) varying over time. In operation, regarding the first scanning line numbered i and the second scanning line i+(n/a), at the start time, a first scanning signal is generated by the scanning line driving circuit 50, and are applied to the first scanning line 11 numbered i. The gradation voltage data are generated by the signal line driving circuits 51, and are sequentially applied to the first signal lines 21 numbered i. The first TFT 31 connected to the first scanning line 11 is open and the gradation voltage is applied to the pixel electrode 41 via the source electrode 311 and the drain electrode 312. The gradation voltage written to the pixel electrodes 41 are used to control the amount of light transmission of the corresponding pixel units and consequently provide an image display for the active matrix LCD 10. After the time t, the second scanning line 12 numbered (n/a)+i is opened, a second scanning signal is generated by the scanning line driving circuit 50, and are applied to the second scanning line 12 numbered (n/a)+i. A black-insertion voltage data are generated by the signal line driving circuits 51, and are sequentially applied to the second signal lines 22 numbered (n/a)+i. The second TFT 32 connected to the second scanning line 12 numbered (n/a)+i is open and the black-insertion voltage is applied to the pixel electrode 41 via the source electrode 321 and the drain electrode 322. The black-insertion voltage written to the pixel electrodes 41 are used to control the amount of light transmission of the corresponding pixel units and consequently provide a black image display for the active matrix LCD 10.

Unlike with the above-described conventional active matrix LCD 100, the active matrix LCD 10 applies a black-insertion voltage in each frame time. The second TFTs 32 connected to the second scanning line 12 opens in turn and delays after the corresponding first TFTs 31 connected to the first scanning line 11 opens, and the second signal line 22 supply a black-insertion voltage to reset the liquid crystal black when the second TFT 22 opens. Therefore, there's a black image display between two continue display pictures. With this mode of operation, a viewer's eyes perceive the black image during the frame time, and any afterimage of the image displayed that would otherwise exist in the viewer's eyes is lost. Accordingly, there is no afterimage that can overlap with the viewer's perception of the displayed image of the next frame period. This means that from the viewpoint of a user, the image quality of the displayed image is clear.

In alternative embodiments, for example, pulse index a can be decided according to the design or the needs of display luminance. The second signal line 22 supply a high voltage to reset the liquid crystal black when the second TFT opens 32, and the high voltage is higher than a gradation voltage provided by the first signal line 21. The high voltage provided by the second signal line 22 is 4-10V, preferred 4V.

It is to be further understood that even though numerous characteristics and advantages of preferred embodiments have been set out in the foregoing description, together with details of the structures and functions of the embodiments, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. An active matrix liquid crystal display (LCD), comprising:
a plurality of first and second scanning lines that are parallel to each other and that each extend along a first direction;
a plurality of first and second signal lines that are parallel to each other and that each extend along a second direction orthogonal to the first direction;
a plurality of scanning connection lines electrically connecting with the first and the second scanning lines;
a plurality of first thin film transistors (TFTs) each provided in the vicinity of a respective point of intersection of the first scanning lines and the first signal lines;
a plurality of second thin film transistors (TFTs) each provided in the vicinity of a respective point of intersection of the second scanning lines and the second signal lines;
wherein the second TFTs connected to the second scanning line opens in turn and delays after the corresponding first TFTs connected to the first scanning line opens, and the second signal line supply a black-insertion voltage to reset the liquid crystal black when the second TFT opens.

2. The active matrix LCD as claimed in claim 1, further comprising a plurality of scanning line driving circuits for providing a plurality of scanning signal to the scanning lines.

3. The active matrix LCD as claimed in claim 2, further comprising a plurality of signal line driving circuits for providing gradation voltage data to the signal lines when an image scanning signal is provided to the scanning lines by the scanning line driving circuits.

4. The active matrix LCD as claimed in claim 1, wherein the second signal line supply a high voltage to reset the liquid crystal black when the second TFT opens, and the high voltage is higher than a gradation voltage provided by the first signal line.

5. The active matrix LCD as claimed in claim 4, wherein the high voltage provided by the second signal line is 4-10V.

6. The active matrix LCD as claimed in claim 4, wherein the high voltage provided by the second signal line is 4V.

7. The active matrix LCD as claimed in claim 1, wherein the first TFTs and the corresponding second TFTs are respectively scanned in a frame time.

8. The active matrix LCD as claimed in claim 1, wherein the first scanning line numbered i electrically connects with the second scanning line numbered (n/a)+i, when (n/a)+i≦n; and the first scanning line numbered i electrically connects with the second scanning line numbered (n/a)+i−n, when (n/a)+i≧n, n being the number of the first scanning lines, and a being a pulse index.

9. The active matrix LCD as claimed in claim 8, wherein the pulse index a is a display time t divided by a frame time T, i.e. a=t/T, and n is integral times of pulse index a.
